(19) United States
(12) Patent Application Publication
(10) Pub. No.: US 2017/0363201 A1
(43) Pub. Date: Dec. 21, 2017

(54) SHIFT-LEVER ASSEMBLY FOR MANUAL TRANSMISSION

(71) Applicants: Hyundai Motor Company, Seoul (KR); Kyung Chang Industrial Co., Ltd., Daegu (KR)

(72) Inventors: Jeong Seon Min, Hwaseong (KR); Young Geun Kim, Daegu (KR)

(21) Appl. No.: 15/276,267

(22) Filed: Sep. 26, 2016

(30) Foreign Application Priority Data
Jun. 15, 2016 (KR) 10-2016-0074640

(51) Int. Cl. F16H 59/04; F16H 59/02

(52) U.S. Cl. CPC F16H 59/04; F16H 2059/026

(57) ABSTRACT

A shift-lever assembly for a manual transmission is provided. The assembly includes a rotary member that is rotatably coupled to a lower portion of a main rod and mounting portions that are connected to mount a shift cable to respective pieces of the rotary member. The rotary member is divided into the plurality of pieces. A shift shaft for a shift operation and a select shaft for a selecting operation are separated from each other to prevent the mounting portions, operated relative to each other during an operation of the main rod, from rotating.

### CROSS REFERENCE TO RELATED APPLICATION

The present application claims priority to Korean Patent Application No. 10-2016-0074640, filed Jun. 15, 2016, the entire contents of which is incorporated herein for all purposes by this reference.

### BACKGROUND

### 1. Field of the Invention

The present invention relates to a shift-lever assembly for a manual transmission, and more particularly, to a shift-lever assembly for a manual transmission that prevents a shift cable from being bent when a selecting operation is performed in the manual transmission to shift gears during the travel of a vehicle, and consequently preventing durability from being decreased.

### 2. Description of the Related Art

Generally, a transmission for a vehicle is classified into a manual transmission, an automatic transmission, and a continuously variable transmission according to the shift method, and is an apparatus that converts the torque and rotation of an engine based on a travel condition. Such a transmission may be shifted to a desired gear shift stage by manipulating a shift lever, and is divided into a manual transmission mode wherein the gear shift stage may be adjusted by a user, and an automatic transmission mode that automatically changes the gear shift stage based on a speed when a user selects a travel mode.

In addition, recently, a shift mode capable of performing both manual shifting and automatic shifting in one transmission has being applied. In other words, a user may manually shift the gear to a high or low stage while the automatic shift mode is enabled. Alternatively, a transmission for automatic shifting may be provided next to a transmission for manual shifting. The manual transmission may be operated separately in a selection process in which a user moves a shift-lever in a transverse direction of a vehicle, and a shift process in which the shift-lever is moved in a longitudinal direction of the vehicle in a state where a selector is selected.

A conventional shift-lever of a manual transmission is configured with a shift cable and a select cable connected, respectively, to a lower portion of an actuating rod. Therefore, the shift cable and the select cable should be separately actuated to allow a gear shift operation to be smoothly performed and to improve handling feeling. However, a shift-lever assembly currently being used is configured with the shift process and the selection process performed by one ball hinge coupled to the lower portion of the actuating rod, and thus, the shift cable may be bent in the selection process except for a ¾ stage disposed at a center, and thereby an unnecessary operating force is increased and the durability of the shift cable is reduced.

The foregoing is designed merely to aid in the understanding of the background of the present invention, and is not intended to mean that the present invention falls within the purview of the related art that is already known to those skilled in the art.

### SUMMARY

Accordingly, the present invention provides a shift-lever assembly for a manual transmission, whereby the assembly may prevent a shift cable from being bent in a selection process, and is thus capable of improving handling feeling and increasing the durability of components.

The present invention is intended to provide a shift-lever assembly for a manual transmission, the assembly may include a rotary member rotatably coupled to a lower portion of a main rod; and mounting portions connected to mount a shift cable to respective pieces of the rotary member, the rotary member being divided into the plurality of pieces, wherein a shift shaft for a shift operation and a select shaft for a selecting operation are separated from each other, thus preventing the mounting portions, operated relative to each other during an operation of the main rod, from rotating.

The rotary member may include both the shift shaft for the shift operation and the select shaft for the selecting operation, the shift shaft and the select shaft being arranged to cross each other. The plurality of pieces of the rotary member may include two hemispherical pieces divided by cutting the spherical rotary member along a cutting line taken in a transverse direction of a vehicle, the pieces (e.g., parts) of the rotary member including a first rotary member on a front side and a second rotary member on a rear side, the first rotary member may include a first mounting portion laterally connected thereto, the shift cable being coupled to the first mounting portion, and the second rotary member may include a second mounting portion downwardly connected thereto, the shift cable being coupled to the second mounting portion.

The first mounting portion may be integrally formed with the first rotary member. Additionally, the first rotary member may include a first coupling portion that extends upwards, with a first insert aperture being formed in a top of the first coupling portion, so that the main rod may be inserted through the first insert aperture into the first rotary member piece. The second mounting portion may be formed separately from the second rotary member piece, the second rotary member piece may include a second coupling portion that extends downwards, with a second insert aperture being formed in a bottom of the second coupling portion, so that the second mounting portion may be inserted through the second insert aperture into the second rotary member piece.

The first rotary member piece may include the first coupling portion that extends upwards at a point corresponding to a central axis in an up-down direction of the rotary member, with the first insert aperture being formed in the top of the first coupling portion, and thus, the main rod may be inserted therein. The second rotary member may include the second coupling portion that extends downwards at the point that corresponds to the central axis in the vertical direction of the rotary member, with the second insert aperture being formed in the bottom of the second coupling portion, and thus, the second mounting portion may be inserted therein. Each of the coupling portions may protrude from a cut plane of the associated rotary member, and thus, the second rotary member may be disposed under the first coupling portion, and the first rotary member may be disposed above the second coupling portion.

The cut plane of the first rotary member and the cut plane of the second rotary member may come into close contact (e.g., abutting contact) with each other to be fastened together, thus forming a fastening plane, a lower surface of the first coupling portion may be disposed in front of the fastening plane, and an upper surface of the second coupling portion may be disposed in back of the fastening plane, and thus, a step or protrusion may be formed by the lower surface of the first coupling portion, the cut planes, and the upper surface of the second coupling portion.

The second mounting portion may be placed on an imaginary straight line that extends in a vertical direction from a lower end of the main rod. A plurality of ribs may be formed at predetermined intervals on an outer circumference of the rotary member, each of the ribs having a longitudinal direction thereof in the vertical direction. The plurality of rotary member pieces and the main rod may be fastened to each other using a fastening member provided separately, the fastening member operating as a rotating shaft of the rotary member.

The shift-lever assembly for the manual transmission configured as described above prevents the shift cable from being bent in a selecting operation when the shift-lever of the manual transmission is operated for the purpose of gear shifting, thus improving handling feeling. Further, the bending of the shift cable may be completely prevented, and thus, the durability of the shift cable may be increased. Moreover, this shift-lever assembly may use an existing ball hinge, thus minimizing the number of components, simplifying a configuration, and decreasing associated costs, compared to a configuration using a complex U-joint

### BRIEF DESCRIPTION OF THE DRAWINGS

The above and other objects, features and advantages of the present invention will be more clearly understood from the following detailed description taken in conjunction with the accompanying drawings, in which:

FIG. 1 is a view illustrating a shift-lever assembly for a manual transmission according to an exemplary embodiment of the present invention;

FIG. 2 is a detailed view illustrating the shift-lever assembly for the manual transmission according to the exemplary embodiment of the present invention;

FIG. 3 is a view illustrating a state in which a first rotary member and a main rod are coupled with each other according to the exemplary embodiment of the present invention;

FIG. 4 is a view illustrating a state in which a second rotary member and a second mounting portion are coupled with each other according to the exemplary embodiment of the present invention;

FIG. 5 is a view illustrating a state in which the shift-lever assembly of FIG. 2 is assembled according to the exemplary embodiment of the present invention; and

FIG. 6 is a side view of FIG. 5 according to the exemplary embodiment of the present invention.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Although exemplary embodiment is described as using a plurality of units to perform the exemplary process, it is understood that the exemplary processes may also be performed by one or plurality of modules. Additionally, it is understood that the term controller refers to a hardware device that includes a memory and a processor. The memory is configured to store the modules and the processor is specifically configured to execute said modules to perform one or more processes which are described further below.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/of” includes any and all combinations of one or more of the associated listed items.

Hereinafter, a shift-lever assembly for a manual transmission according to an exemplary embodiment of the present invention will be described with reference to the accompanying drawings.

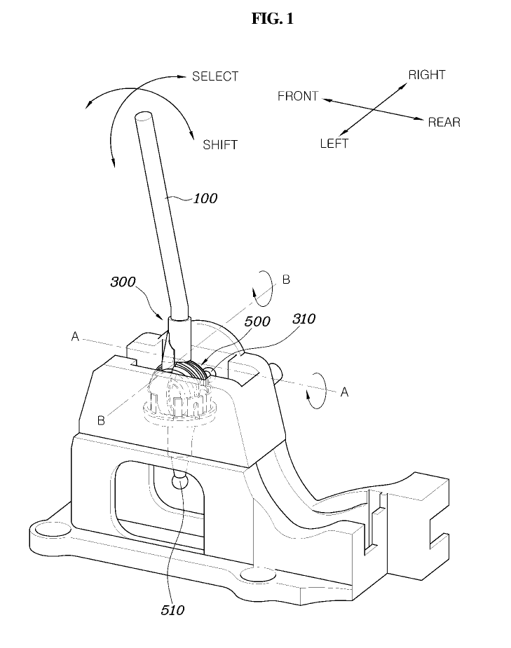

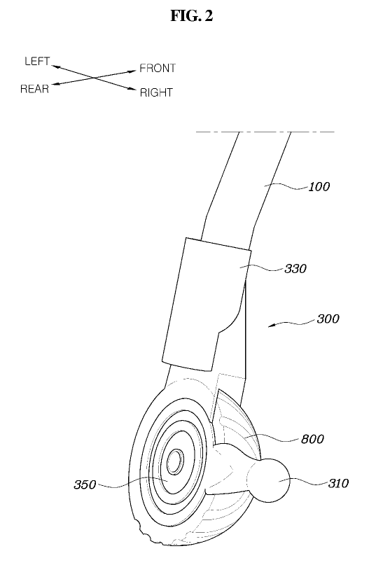

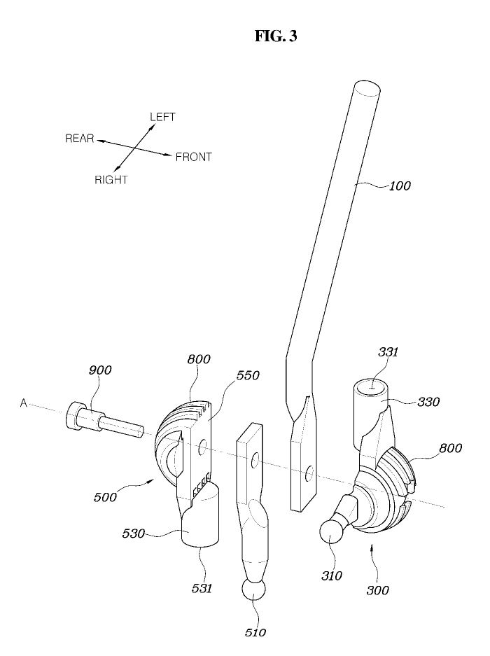

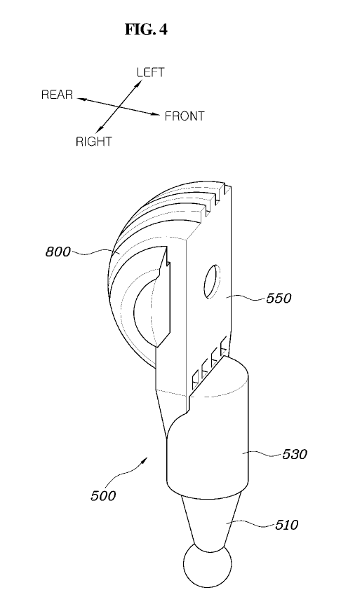

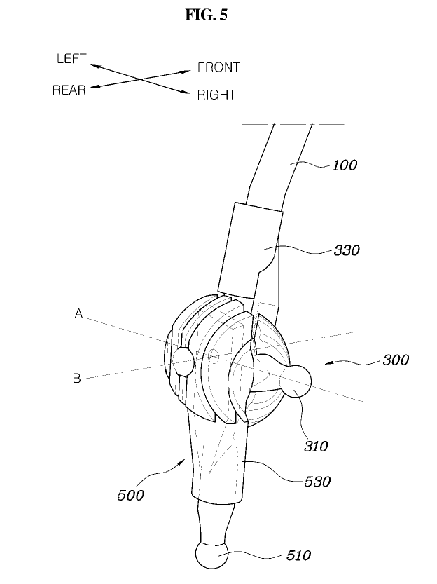

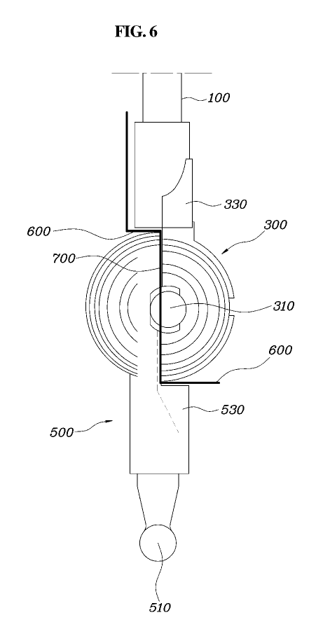

FIG. 1 is a view illustrating a shift-lever assembly for a manual transmission according to an exemplary embodiment of the present invention, and FIG. 2 is a detailed view illustrating the shift-lever assembly for the manual transmission according to the exemplary embodiment of the present invention. Further, FIG. 3 is a view illustrating a state in which a first rotary member 300 and a main rod 100 are coupled with each other, FIG. 4 is a view illustrating a state in which a second rotary member 500 and a second mounting portion 510 are coupled with each other, FIG. 5 is a view illustrating a state in which the shift-lever assembly of FIG. 2 is assembled, and FIG. 6 is a side view of FIG. 5. FIG. 1 illustrates a state in which the shift-lever assembly is mounted to a vehicle, and FIGS. 2 to 6 illustrate a state in which the shift-lever assembly has a symmetric structure in a front-rear direction and a left-right direction to more easily view a first mounting portion 310.

The shift-lever assembly for the manual transmission according to the exemplary embodiment of the present invention may include a rotary member 300, 500 rotatably coupled to a lower portion of a main rod 100, and mounting portions 310 and 510 connected to mount a shift cable to respective pieces of the rotary member 300, 500, the rotary member being divided into the plurality of pieces. Therefore, a shift shaft for a shift operation and a select shaft for a selecting operation may be separated from each other, thus preventing the mounting portions, operated relative to each other during an operation of the main rod 100 for a gear shift, from rotating. In other words, the rotary member 300, 500 may include both the shift shaft for the shift operation and the select shaft for the selecting operation, the shift shaft and the select shaft being arranged to cross each other in the rotary member 300, 500.

In particular, the plurality of pieces of the rotary member 300, 500 may include two hemispherical pieces divided by cutting the spherical rotary member 300, 500 along a cutting line taken in a transverse direction of a vehicle, and may include a first rotary member 300 on a front side and a second rotary member 500 on a rear side. The first rotary member 300 may include a first mounting portion 310 laterally connected thereto, the shift cable being coupled to the first mounting portion, and the second rotary member 500 may include a second mounting portion 510 downwardly connected thereto, the shift cable being coupled to the second mounting portion. When a gear shift stage change is requested or intended by a user, the operation of the main rod 100 for the shift requires a greater rigidity compared to the operation of the main rod 100 for the selection. Accordingly, the select cable for selecting the gear shift stage may be connected to the first rotary member 300 and the shift cable for shifting the gear shift stage may be connected to the second rotary member 500.

The present invention will be illustrated and described with reference to the exemplary embodiment in which the rotary member 300, 500 is divided along the cutting line taken in the transverse direction of the vehicle, the select cable is connected to the first mounting portion 310, and the shift cable is connected to the second mounting portion 510. However, the cutting line or a configuration for connecting the mounting portions 310 and 510 with the cables may be freely changed based on a design or an environment.

Therefore, in the shift-lever assembly for the manual transmission according to the present invention, the first rotary member 300 may have a hemispherical shape facing the front side of the vehicle. The first mounting portion 310 may be integrally formed with the first rotary member 300. Particularly, the first mounting portion 310 may be laterally connected to a point that corresponds to a central axis in a transverse direction of the rotary member 300, 500. In other words, when the first mounting portion 310 deviates from the central axis in the transverse direction of the first rotary member piece 300, it may be difficult to realize an accurate operation when the main rod 100 is operated, and operating efficiency and handling feeling may be undesirably reduced.

Further, the first rotary member 300 may include a pipe-shaped first coupling portion 330 that extends upwards, with a first insert aperture 331 being formed in a top of the first coupling portion. The first coupling portion 330 may be aligned with an imaginary straight line that extends in a vertical direction from a lower end of the main rod 100, namely, the central axis in the vertical direction of the rotary member 300, 500. Thus, such a configuration may provide a more accurate operation, and improve operating efficiency and handling feeling, similarly to a configuration in which the first mounting portion 310 is formed on the central axis in the transverse direction of the vehicle. Further, the main rod 100 may be inserted through the first insert aperture 331 of the first coupling portion 330 into the first rotary member piece 300. The main rod 100 and the first rotary member piece 300 may be coupled with each other through double injection molding.

The second rotary member 500 may have a hemispherical shape facing the rear side of the vehicle. The second mounting portion 510 may be formed separately from the second rotary member 500 and then may be inserted therein. The second rotary member 500 may include a pipe-shaped second coupling portion 530 that extends downwards, with a second insert aperture 531 being formed in a bottom of the second coupling portion. The second coupling portion 530 may extend downwards at a point that corresponds to the central axis in the vertical direction of the rotary member 300, 500. Therefore, the second mounting portion 510 may be disposed on the imaginary straight line that extends in the vertical direction from the lower end of the main rod 100. In other words, similarly to the first mounting portion 310, when the second mounting portion 510 deviates from the central axis in the up-down direction of the second rotary member piece 500, it may be difficult to realize an accurate operation when the main rod 100 is operated, and operating efficiency and handling feeling may be undesirably reduced.

The second mounting portion 510, formed separately, may be inserted through the second insert aperture 531 of the second coupling portion 530 in a direction from a bottom to a top. In particular, the second mounting portion 510 may be molded molded and then inserted into the second rotary member piece 500 since the shift operation requires a greater rigidity compared to the first mounting portion 310 that performs the selecting operation. The second coupling portion 530 and the second rotary member piece 500 may be coupled with each other through double injection molding.

In other words, the first rotary member 300 may include the first coupling portion 330 that extends upwards at a point that corresponds to the central axis in the vertical direction of the rotary member 300, 500, with the first insert aperture 331 being formed in the top of the first coupling portion to insert the main rod 100 therein. The second rotary member 500 may include the second coupling portion 530 that extends downwards at the point that corresponds to the central axis in the vertical direction of the rotary member 300, 500, with the second insert aperture 531 being formed in the bottom of the second coupling portion to insert the second mounting portion 510 therein. Each of the coupling portions may protrude from a cut plane 350, 550 of the associated rotary member piece 300, 500, to dispose the second rotary member piece 500 under the first coupling portion 330, and the first rotary member piece 300 above the second coupling portion 530.

The cut plane 350 of the first rotary member 300 and the cut plane 550 of the second rotary member 500 may come into close contact with each other (e.g., may abut) to be fastened together, thus forming a fastening plane 700. A lower surface of the first coupling portion 330 may be disposed in front of the fastening plane 700, and an upper surface of the second coupling portion 530 may be disposed in back of the fastening plane 700, to form a step 600 (e.g., protrusion, flange, etc.) by the lower surface of the first coupling portion 330, the cut planes 350 and 550, and the upper surface of the second coupling portion 530.

Therefore, the step 600 causes the main rod 100 to rotate about the select shaft A on the fastening plane 700 during the selecting operation, and thus, the operating force of the main rod 100 is not transmitted to the second rotary member piece 500. Further, during the shifting operation, the first rotary member 300 may press or exert force onto the second rotary member 500 through the fastening plane 700 about the shift shaft B, and thus, the second mounting portion 510 may be disposed on or moved onto the shift shaft B. Consequently, it may be possible to perform the shift operation without affecting the selecting operation. Further, a plurality of ribs 800 may be formed at predetermined intervals on an outer circumference of the rotary member 300, 500, each of the ribs having a longitudinal direction in the vertical direction. Therefore, it may be possible to increase the rigidity of the rotary member 300, 500.

A lower portion of the main rod 100 may have the shape of a plate that is parallel to the cut plane 350 of the first rotary member 300. Further, an upper portion of the second mounting portion 510 may have the shape of a plate that is parallel to the cut plane 550 of the second rotary member 500. Therefore, the second rotary member 500, the second mounting portion 510, the main rod 100, and the first rotary member 300 may be supported over a greater area, due to plane-to-plane contact, to be more firmly coupled with each other. Additionally, apertures may be formed in the plurality of rotary member pieces 300 and 500 and the main rod 100. The apertures may be fastened to each other using a fastening member 900 provided separately. The fastening member 900 may operate as the rotating shaft of the rotary member 300, 500.

As described above, the present invention provides a shift-lever assembly for a manual transmission, which prevents a shift cable from being bent in a selecting operation when a shift-lever of the manual transmission is operated for the purpose of gear shifting, thus improving handling feeling. Further, the bending of the shift cable may be completely prevented, thus increasing the durability of the shift cable. Moreover, this shift-lever assembly utilizes an existing ball hinge, thus minimizing the number of components, simplifying a configuration, and reducing associated costs, compared to a configuration using a complicated U-joint.

Although the exemplary embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A shift-lever assembly for a manual transmission, comprising:
a rotary member rotatably coupled to a lower portion of a main rod; and
mounting portions connected to mount a shift cable to respective pieces of the rotary member, the rotary member being divided into the plurality of pieces,
wherein a shift shaft for a shift operation and a select shaft for a selecting operation are separated from each other to prevent the mounting portions, operated relative to each other during an operation of the main rod, from rotating.

2. The shift-lever assembly of claim 1, wherein the rotary member includes both the shift shaft for the shift operation and the select shaft for the selecting operation, the shift shaft and the select shaft being arranged to cross each other.

3. The shift-lever assembly of claim 1, wherein the plurality of pieces of the rotary member includes two hemispherical pieces divided by cutting the spherical rotary member along a cutting line taken in a transverse direction of a vehicle, the pieces of the rotary member including:
a first rotary member on a front side and a second rotary member on a rear side,
wherein the first rotary member includes a first mounting portion laterally connected thereto, the shift cable being coupled to the first mounting portion, and
wherein the second rotary member includes a second mounting portion downwardly connected thereto, the shift cable being coupled to the second mounting portion.

4. The shift-lever assembly of claim 3, wherein the first mounting portion is integrally formed with the first rotary member.

5. The shift-lever assembly of claim 3, wherein the first rotary member includes a first coupling portion that extends upwards, with a first insert aperture being formed in a top of the first coupling portion to insert the main rod through the first insert aperture into the first rotary member.

6. The shift-lever assembly of claim 3, wherein the second mounting portion is formed separately from the second rotary member, the second rotary member includes a second coupling portion that extends downwards, with a second insert aperture being formed in a bottom of the second coupling portion to insert the second mounting portion through the second insert aperture into the second rotary member.

7. The shift-lever assembly of claim 3, wherein:
the first rotary member includes the first coupling portion that extends upwards at a point that corresponds to a central axis in a vertical direction of the rotary member, with the first insert aperture being formed in the top of the first coupling portion to insert the main rod therein,
the second rotary member includes the second coupling portion that extends downwards at the point that corresponds to the central axis in the vertical direction of the rotary member, with the second insert aperture being formed in the bottom of the second coupling portion to insert the second mounting portion therein, and
each of the coupling portions protrudes from a cut plane of the associated rotary member piece, to dispose the second rotary member under the first coupling portion and disposed the first rotary member above the second coupling portion.

8. The shift-lever assembly of claim 7, wherein the cut plane of the first rotary member and the cut plane of the second rotary member abut each other to be fastened together to form a fastening plane.

9. The shift-lever assembly of claim 8, wherein a lower surface of the first coupling portion is disposed in front of the fastening plane and an upper surface of the second coupling portion is disposed in back of the fastening plane to form a step by the lower surface of the first coupling portion, the cut planes, and the upper surface of the second coupling portion.

10. The shift-lever assembly of claim 3, wherein the second mounting portion is disposed on an imaginary straight line that extends in a vertical direction from a lower end of the main rod.

11. The shift-lever assembly of claim 1, wherein a plurality of ribs are formed at predetermined intervals on an outer circumference of the rotary member, each of the ribs having a longitudinal direction thereof in the vertical direction.

12. The shift-lever assembly of claim 1, wherein the plurality of rotary member pieces and the main rod are fastened to each other using a fastening member provided separately, the fastening member operating as a rotating shaft of the rotary member.
